(19) United States
(12) Patent Application Publication
(10) Pub. No.: US 2019/0224862 A1
(43) Pub. Date: Jul. 25, 2019

(54) CARVING KNIFE

(71) Applicant: NINGBO YINZHOU YONGJIA ELECTRICAL TOOLS CO., LTD., Ningbo City (CN)

(72) Inventors: Hongguang HOU, Ningbo City (CN); Zhili ZHOU, Ningbo City (CN); Xiaoqun JIN, Ningbo City (CN)

(21) Appl. No.: 15/894,186

(22) Filed: Feb. 12, 2018

(30) Foreign Application Priority Data
Jan. 25, 2018 (CN) 201810072778.1

(51) Int. Cl. B26B 11/00; B26B 5/00; B44B 11/00; F21V 23/04

(52) U.S. Cl. CPC B26B 11/008; B26B 5/00; B44B 2700/12; F21V 23/0421; B44B 11/00

(57) ABSTRACT

The invention provides a carving knife. The carving knife comprises a knife handle, a blade, a light-emitting structure and a switch structure, wherein the blade is inserted into the front end of the knife handle, the light-emitting structure is mounted on the knife handle and located near the blade, the switch structure is arranged on the knife handle, electrically connected with the light-emitting structure and used for controlling on-off of the light-emitting structure. The carving knife has the advantages of being high in integration level and comfortable in use.

### CROSS-REFERENCE OF RELATED APPLICATIONS

This application claims priority under 35 USC § 119 to Chinese Patent Application No. 201810072778.1, filed on Jan. 25, 2018. The disclosure of the above-identified application is hereby incorporated by reference.

### TECHNICAL FIELD

The invention belongs to the technical field of carving tools, and relates to a carving knife.

### DESCRIPTION OF RELATED ART

Carving knives are special tools usually used by craftsmen to carve artwork made of various materials such as wood, jade and stone. Carving tools are the most direct tools used by gravers for creation, and in the manufacturing process of carvings, carving knives and auxiliary tools thereof are of great importance.

In the prior art, a carving knife is simple in structural design, generally only includes a knife handle and a blade, and can be used for carving lines only, thereby being poor in practicability and comfort in use. On this account, the invention provides a carving knife which is reasonable in design, high in integration level and comfortable in use.

### BRIEF SUMMARY OF THE INVENTION

To solve the above problems of the prior art, the invention provides a carving knife which is high in integration level and comfortable in use.

According to the technical scheme adopted by the invention, a carving knife comprises:

a knife handle;

a blade inserted into the front end of the knife handle;

a light-emitting structure mounted on the knife handle and located near the blade;

a switch structure arranged on the knife handle, electrically connected with the light-emitting structure and used for controlling on-off of the light-emitting structure.

As a further improvement of the invention, the light-emitting structure comprises light-emitting elements separately arranged on the two sides of the blade.

As a further improvement of the invention, one light-emitting element is arranged on each side of the blade, the front end of the knife handle is provided with mounting grooves in one-to-one correspondence with the light-emitting elements, and the light-emitting elements and the blade are inserted into the front end of the knife handle in the same direction.

As a further improvement of the invention, the knife handle comprises a shell and a front cover detachably mounted at the front end of the shell, the blade is inserted into the middle of the front cover, the mounting grooves are formed in the front cover, and the light-emitting elements are inserted into the front cover.

As a further improvement of the invention, a blade insert is arranged between the front cover and the shell, after the front cover and the shell are assembled together, the blade insert is located in the knife handle, and when the blade is inserted into the front cover, the blade is limited by the blade insert.

As a further improvement of the invention, a press knob is movably mounted on the upper portion of the front cover and divided into a knob part and a press part located under the knob part, the press part penetrates through the front cover to be matched with the blade insert, and the knob part can be rotated to drive the press part to move up and down, so that the blade is limited in the blade insert.

As a further improvement of the invention, the shell is provided with an inner cavity with an opening, the opening of the inner cavity is formed in the rear end of the shell, and the knife handle further comprises a rear cover which is detachably mounted at the rear end of the shell and seals the opening of the inner cavity.

As a further improvement of the invention, the switch structure comprises a control switch located on the upper portion of the knife handle, and the control switch can be pressed to turn on or off the light-emitting structure.

As a further improvement of the invention, a switch groove used for mounting the switch structure is formed in the knife handle, the switch structure comprises a power supply and a seal cover, the power supply is electrically connected with the control switch, the seal cover is detachably mounted on the knife handle and seals the switch groove, and the control switch penetrates through the seal cover and is partially exposed.

As a further improvement of the invention, a protective jacket provided with an anti-slip structure is tightly mounted on the lower portion of the shell.

Based on the above technical scheme, the embodiment of the invention at least has the following technical effects: the carving knife is reasonable in overall structural design, compact in layout and high in integration level, and the coherent and highly-integrated carving knife can be used comfortably and easily; the light-emitting structure is arranged near the blade, and the switch structure convenient to operate is arranged cooperatively so that the carving knife can operate in dark environment or on other adaptive occasions and can also be found in dark environments; when the carving knife operates, the light-emitting structure can be turned on to light up slots/seams or other positions of a carved object, so that operation accuracy is improved, the quality of a finished carving is ensured, and the defective rate is decreased; and in addition, the carving knife can also be independently used as a tool with an illumination function, thereby being high in practicability and convenient to carry, transport and store.

### BRIEF DESCRIPTION OF THE SEVERAL VIEWS OF THE DRAWINGS

A further detailed description of the specific embodiments of the invention is given with accompanying drawings as follows, wherein,

FIG. 1 is a structural diagram of a preferred embodiment of the invention;

FIG. 2 is an exploded view of a preferred embodiment of the invention.

In the FIGS.: 10, knife handle; 11, shell; 111, inner cavity; 112, switch groove; 12, front cover; 121, mounting groove; 13, rear cover; 20, blade; 30, light-emitting structure; 31, light-emitting element; 40, switch structure; 41, control switch; 42, power supply; 43, seal cover; 44, control panel; 50, blade insert; 60, press knob; 70, protective jacket.

### DETAILED DESCRIPTION OF THE INVENTION

A further description of the technical scheme of the invention is given with specific embodiments and accompanying drawings of the invention as follows, but the invention is not limited to the following embodiments.

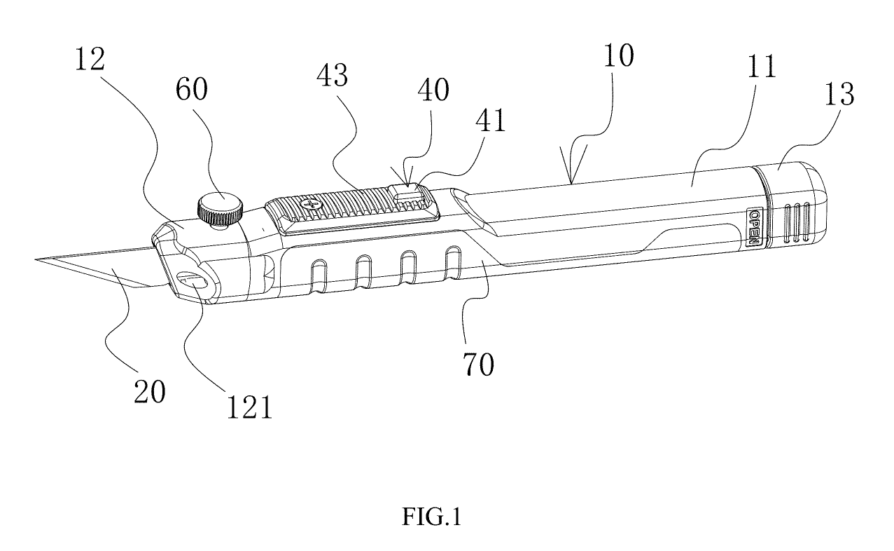

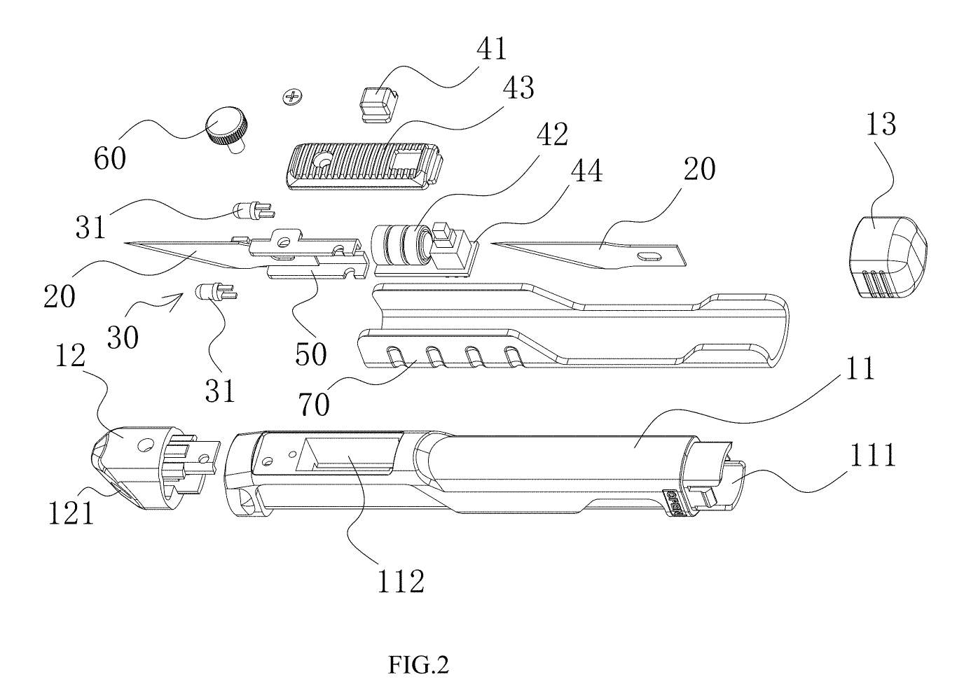

A more detailed illustration of the technical scheme of the invention is given with FIG. 1 and FIG. 2 as follows.

As is shown in FIG. 1 and FIG. 2, a carving knife comprises:

a knife handle 10, wherein the knife handle 10 serves as the handheld part of the whole carving knife and also serves as a support carrier, and the whole knife handle 10 is approximately of a rod structure;

a blade 20, wherein the blade 20 is inserted into the front end of the knife handle 10 in the axial direction of the knife handle 10;

a light-emitting structure 30, wherein the light-emitting structure 30 is mounted on the knife handle 10 and located near the blade 20;

a switch structure 40, wherein the switch structure 40 is arranged on the knife handle 10 and electrically connected with the light-emitting structure 30, and the switch structure 40 is used for controlling on-off of the light-emitting structure 30.

The carving knife of the invention is reasonable in overall structural design, compact in layout and high in integration level, and the coherent and highly-integrated carving knife can be used comfortably and easily. The light-emitting structure 30 is arranged near the blade 20, and the switch structure 40 convenient to operate is arranged cooperatively so that the carving knife can operate in dark environments or on other suitable occasions and can also be conveniently found in dark environments. Furthermore, when the carving knife operates, the light-emitting structure 30 can be turned on to light up slots/seams or other positions of the carved object, so that operation accuracy is improved, the quality of the finished carving is ensured, and the defective rate is decreased. In addition, the carving knife can also be independently used as a tool with an illumination function, thereby being high in practicability and convenient to carry, transport and store.

As a preferred or alternative embodiment, the light-emitting structure 30 comprises light-emitting elements 31 separately arranged on the two sides of the blade 20, so that the illumination effect is better, and the space around the blade 20 is covered with light.

Furthermore, one light-emitting element 31 is arranged on each side of the blade, the front end of the knife handle 10 is provided with mounting grooves 121 in one-to-one correspondence with the light-emitting elements 31, and the light-emitting elements 31 and the blade 20 are inserted into the front end of the knife handle 10 in the same direction.

Preferably, the mounting grooves 121 are formed in the knife handle 10 also in the axial direction, namely the blade 20 and the light-emitting elements 31 are all arranged at the front end of the knife handle 10 in the axial direction of the knife handle 10, and the two light-emitting elements 31 are separately arranged on the two sides of the blade 20 so that light emitted by the light-emitting elements can be distributed all around the blade 20, light emitted in the axial direction can be protected against interferences from the blade 20 to the maximum extent, thereby being more concentrated, and the light which is not shielded can better light up the space ahead.

In the scheme, the light-emitting elements 31 are preferably adaptive structures such as small bulbs or lamp beads and are convenient to mount and low in cost, so that the integration effect of the carving knife is more excellent. Furthermore, the light-emitting elements 31 are preferably arranged in the mounting grooves 121 and not exposed out from the knife handle 10 so as to be protected against damage, and the light-emitting effect is not affected. Moreover, through the cooperation between the light-emitting elements 31 and the mounting grooves 121, emitted light can be more concentrated and is unlikely to diverge.

Preferably, the switch structure 40 comprises a control switch 41 located on the upper portion of the knife handle 10, so that operation is convenient and easier in work; and the control switch 41 can be pressed to turn on or off the light-emitting structure 30, in this way, operation is more convenient and reliable, and the fingers of an operator can have obvious tactile experience.

Furthermore, in the invention, the knife handle 10 comprises a shell 11 and a front cover 12 detachably mounted at the front end of the shell 11, the blade 20 is inserted into the middle of the front cover 12, the mounting grooves 121 are formed in the front cover 12, the light-emitting elements 31 are inserted into the front cover 12, and the control switch 41 is arranged on the upper portion of the shell 11.

The detachable front cover 12 is convenient to mount and maintain, the blade 20 can be dismounted rapidly and conveniently, and the mounting grooves 121 are convenient to machine.

Furthermore, the shell 11 is provided with an inner cavity 111 with an opening, the opening of the inner cavity 111 is formed in the rear end of the shell 11, the inner cavity 111 can accommodate adaptive articles such as the blade 20, and the knife handle 10 further comprises a rear cover 13 which is detachably mounted at the rear end of the shell 11 and seals the opening of the inner cavity 111.

Through the above structure, blades 20 of various specifications can be stored in the inner cavity 111 of the shell 11 in advance and be taken out for use when needed after the rear cover 13 is opened, the blade 20 detached from the carving knife is placed back into the inner cavity 111, in this way, a good storage effect is achieved, and other articles can also be stored. The blade 20 can be detached to be stored in the shell 11 after use, so that parts are unlikely get lost and are also prevented from being exposed and scratched.

For ensuring the limiting effect and the pressing effect of the blade 20 after the blade 20 is inserted into the front cover, preventing the blade 20 from getting loose and ensuring the operating reliability of the carving knife, a blade insert 50 is preferably arranged between the front cover 12 and the shell 11; and after the front cover 12 and the shell 11 are assembled together, the blade insert 50 is located in the knife handle 10, and the blade 20 is limited by the blade insert 50 when the blade 20 is inserted into the front cover 12.

A press knob 60 is movably mounted on the upper portion of the front cover 12 and divided into a knob part and a press part located under the knob part, the press part penetrates through the front cover 12 to be matched with the blade insert 50, and the knob part can be rotated to drive the press part to move up and down, so that the blade 20 is limited in the blade insert 50.

When the press knob 60 is rotated, the press part tightly presses the blade 20 and the blade insert 50, and thus the blade is reliably limited; and when the blade needs to be released, users just need to rotate the press knob reversely, and thus operation is convenient, and work is reliable.

For arranging the switch structure 40 conveniently, reliably and highly integrally, a switch groove 112 used for mounting the switch structure 40 is preferably formed in the knife handle 10. The switch structure 40 comprises a power supply 42 and a seal cover 43, wherein the power supply 42 is electrically connected with the control switch 41, the seal cover 43 is detachably mounted on the knife handle 10 and seals the switch groove 112 (the switch groove 112 is formed in the shell 11), and the control switch 41 penetrates through the seal cover 43 and is partially exposed.

Furthermore, the switch structure 40 comprises a control panel 44 connected with the power supply 42 and the control witch 41, the work time and the like of the light-emitting structure 30 can be set to ensure the operating reliability, and thus the practicability is further improved.

In this way, a good protection effect is achieved, rainwater, dust and other substances are prevented from entering the knife handle 10, and the control switch 41 can be operated without being affected; and the power supply 42 is preferably a replaceable power supply 42 and is further preferably a battery (such as a button battery).

Preferably, for ensuring the anti-slip effect and the comfort in use, a protective jacket 70 provided with an anti-slip structure is tightly mounted on the lower portion of the shell 11; and the seal cover 43 is also preferably provided with an anti-slip structure, so that the seal cover 43 on the upper portion and the protective jacket 70 on the lower portion are matched more tightly, the overall carving knife has a better hand feeling in use and a more ideal anti-slip effect and can operate more reliably and efficiently.

The specific embodiment mentioned above is only used for illustratively describing the spirit of the invention. Those skilled in the field of the invention can make various modifications or supplements or similar substitutes according to the specific embodiment without deviating from the spirit of the invention in the scope defined by the claims.

What is claimed is:

1. A carving knife, comprising:
a knife handle;
a blade inserted into the front end of the knife handle;
a light-emitting structure mounted on the knife handle and located near the blade;
a switch structure arranged on the knife handle, wherein the switch structure is electrically connected with the light-emitting structure and used for controlling operation of the light-emitting structure.

2. The carving knife according to the claim 1, wherein the light-emitting structure comprises light-emitting elements separately arranged on the two sides of the blade.

3. The carving knife according to claim 2, wherein one light-emitting element is arranged on each side of the blade, the front end of the handle is provided with mounting grooves in one-to-one correspondence with the light-emitting elements, and the light-emitting elements and the blade are inserted into the front end of the knife handle in the same direction.

4. The carving knife according to claim 3, wherein the knife handle comprises a shell and a front cover detachably mounted at the front end of the shell, wherein the blade is inserted into the middle of the front cover, mounting grooves are formed in the front cover, and the light-emitting elements are inserted into the front cover.

5. The carving knife according to claim 4, wherein a blade insert is arranged between the front cover and the shell, after the front cover and the shell are assembled together, the blade insert is located in the knife handle, and when the blade is inserted into the front cover, the blade is limited by the blade insert.

6. The carving knife according to claim 5, wherein a press knob is movably mounted on the upper portion of the front cover and divided into a knob part and a press part located under the knob part, the press part penetrates through the front cover to be matched with the blade insert, and the knob part is rotated to drive the press part to move up and down, so that the blade is limited in the blade insert.

7. The carving knife according to claim 4, wherein the shell is provided with an inner cavity with an opening, the opening of the inner cavity is formed in the rear end of the shell, and the knife handle further comprises a rear cover which is detachably mounted at the rear end of the shell and seals the opening of the inner cavity.

8. The carving knife according to claim 1, wherein the switch structure comprises a control switch located on the upper portion of the knife handle, and the control switch can be pressed to turn on or off the light-emitting structure.

9. The carving knife according to claim 8, wherein a switch groove used for mounting the switch structure is formed in the knife handle, the switch structure comprises a power supply and a seal cover, the power supply is electrically connected with the control switch, the seal cover is detachably mounted on the upper portion of the knife handle and seals the switch groove, and the control switch penetrates through the seal cover and is partially exposed.

10. The carving knife according to claim 4, wherein a protective jacket provided with anti-slip structure is tightly mounted on the lower portion of the shell.
